(19) United States
(12) Patent Application Publication
(10) Pub. No.: US 2015/0070298 A1
(43) Pub. Date: Mar. 12, 2015

(54) TOUCH PANEL AND LIQUID CRYSTAL DISPLAY DEVICE USING THE SAME

(71) Applicant: TIANJIN FUNAYUANCHUANG TECHNOLOGY CO.,LTD., Tianjin (CN)

(72) Inventors: PO-SHENG SHIH, New Taipei (TW); CHIH-HAN CHAO, New Taipei (TW); HAN-CHUNG CHEN, New Taipei (TW)

(73) Assignee: TIANJIN FUNAYUANCHUANG TECHNOLOGY CO.,LTD., Tianjin (CN)

(21) Appl. No.: 14/147,460

(22) Filed: Jan. 3, 2014

(30) Foreign Application Priority Data
Sep. 9, 2013 (CN) 201310404921X

(51) Int. Cl. G06F 3/044

(52) U.S. Cl. CPC G06F 3/044
USPC 345/174

(57) ABSTRACT

A touch panel includes a substrate with a surface and a patterned transparent conductive layer located on the surface of the substrate. The patterned transparent conductive layer includes a plurality of pairs of sensor electrodes arranged adjacent to each other in an X direction. Each of the plurality of pairs of sensor electrodes includes a first electrode and a second electrode opposite to the first electrode. A pattern of the first electrode and the second electrode is designed as a right triangle shape or a right angled trapezoid shape. One side of the right triangle shape or the right angled trapezoid shape parallel to a Y direction extends in a plurality of zigzag shapes, wherein the X direction is perpendicular to the Y direction. The present invention also relates to a liquid crystal display device including the touch panel.

### RELATED APPLICATIONS

This application claims all benefits accruing under 35 U.S.C. §119 from China Patent Application No. 201310404921.X, filed on Sep. 9, 2013 in the China Intellectual Property Office, the disclosure of which is incorporated herein by reference.

### BACKGROUND

1. Technical Field

The present application relates to a touch panel and liquid crystal display device using the same.

2. Discussion of Related Art

Following the advancement in recent years of various electronic apparatuses, such as mobile phones, car navigation systems and the like toward high performance and diversification, there has been continuous growth in the number of electronic apparatuses equipped with optically transparent touch panels at the front of their respective display devices (e.g., a display such as a liquid crystal panel). A user of any such electronic apparatus operates it by pressing or touching the touch panel with a finger, a pen, a stylus, or a like tool while visually observing the display device through the touch panel. Therefore, a demand exists for touch panels that are superior in visibility and reliable in operation.

At present, different types of touch panel include resistance-type and capacitance-type. The capacitance-type touch panel has several advantages, such as high accuracy and strong anti jamming ability, and thus has been widely used. Different types of capacitance-type touch panel include mutual-inductance capacitance touch panel and self-inductance capacitance touch panel. The self-inductance capacitance touch panel has several advantages, such as simple structure, simple drive mode and mature preparation technology.

As shown in FIG. 9, a conventional self-inductance capacitance touch panel 10 includes a substrate 12, a transparent conductive layer 14 located on the substrate 12, a protective layer 16 located on the transparent conductive layer 14, and at least two wires 18 spaced to each other. The at least two wires 18 are electrically connected to the transparent conductive layer 14.

In the conventional self-inductance capacitance touch panel 10, conventional patterns of the transparent conductive layer 14 are right triangles, as shown in FIGS. 9 and 10. The transparent conductive layer 14 is etched to a plurality of right triangles, and pixels in a liquid crystal display module are often arranged in rows and columns in horizontal and vertical directions. Thus, when the self-inductance capacitance touch panel 10 is assembled with the liquid crystal display module, an etching direction of an angle right in the transparent conductive layer 14 is parallel with the pixels arrangements of the liquid crystal display module, causing interference of light. As a result, Moire' effects can appear. In general, Moire' effects can be produced by two overlapping entities with regular patterns, and can appear as a regular patter of lines that can be more pronounced if the periodicity of the pattern of one entity is an integer multiple of the periodicity of the pattern of the second entity. Moire' effects can affect visual identification and operation to the self-inductance capacitance touch panel 10.

What is needed, therefore, is to provide a touch panel and liquid crystal display device using the same that can overcome the above-described shortcomings.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of a touch panel.

FIG. 2 is a schematic view of one embodiment of patterns of a transparent conductive layer in the touch panel of FIG. 1.

FIG. 3 is another schematic view of one embodiment of patterns of a transparent conductive layer in the touch panel of FIG. 1.

FIG. 4 is yet another schematic view of one embodiment of patterns of a transparent conductive layer in the touch panel of FIG. 1.

FIG. 5 is a schematic view of one embodiment of a zigzag shape in the transparent conductive layer of FIGS. 2-4.

FIG. 6 is a schematic view of one embodiment of a liquid crystal display device.

FIG. 7 is a schematic view of another embodiment of patterns of a transparent conductive layer in the touch panel of FIG. 1.

FIG. 8 is a schematic view of yet another embodiment of patterns of a transparent conductive layer in the touch panel of FIG. 1.

FIG. 9 is a schematic view of a conventional self-inductance capacitance touch panel of the prior art.

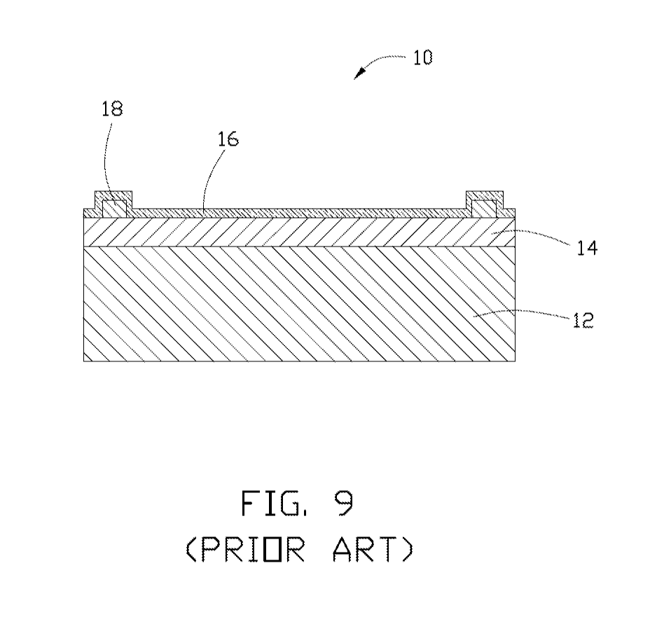

FIG. 10 is a schematic view of a conventional patterns of a transparent conductive layer of the prior art.

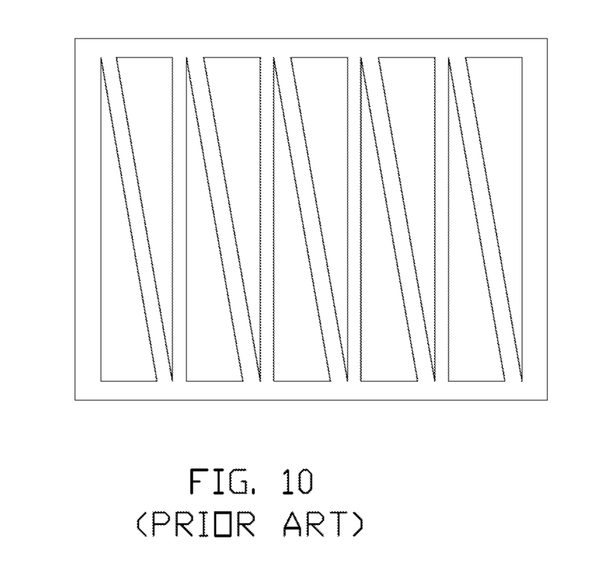

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

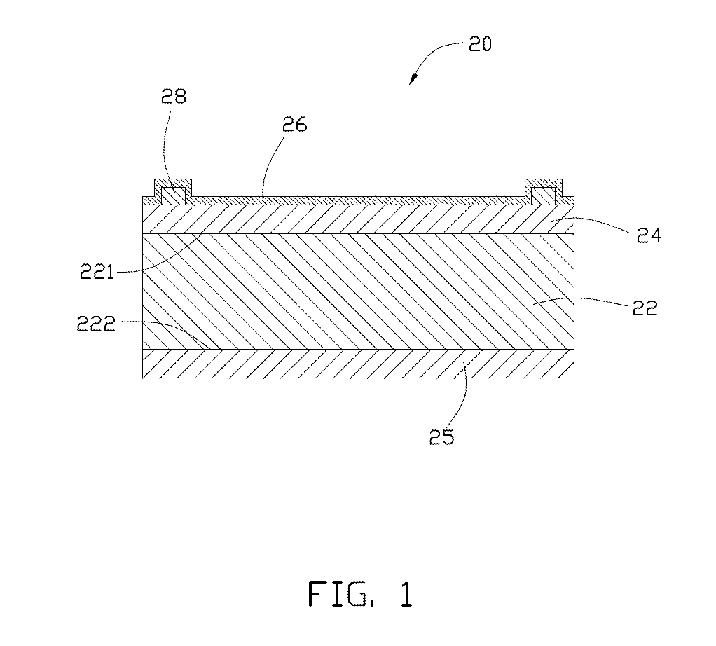

Referring to FIG. 1, a touch panel 20 of one embodiment includes a substrate 22, a transparent conductive layer 24, a protective layer 26 and at least two wires 28. The substrate 22 has a first surface 221 and a second surface 222 opposite to the first surface 221. The transparent conductive layer 24 is located on the first surface 221 of the substrate 22. The at least two wires 28 are electrically connected with the transparent conductive layer 24. The protective layer 26 is directly located on the transparent conductive layer 24. In one embodiment, the touch panel 20 only includes one transparent conductive layer 24. That is, the touch panel 20 can be a single-touch sensor panel, and operated by multi-points in part area.

The substrate 22 for supporting other elements can be a transparent thin film or transparent thin plate. The substrate 22 can be made of rigid materials such as glass, quartz, diamond or any other suitable material. The substrate 22 can also be made of flexible materials such as polycarbonate (PC), polymethyl methacrylate acrylic (PMMA), polyimide (PI), polyethylene terephthalate (PET), polyethylene (PE), polyether polysulfones (PES), polyvinyl polychloride (PVC), benzocyclobutenes (BCB), polyesters, or acrylic resin. A thickness of the substrate 22 can be in a range from about 1 millimeter to about 1 centimeter. In one embodiment, the substrate 22 is made of PET, the thickness of the substrate 22 is about 2 millimeters.

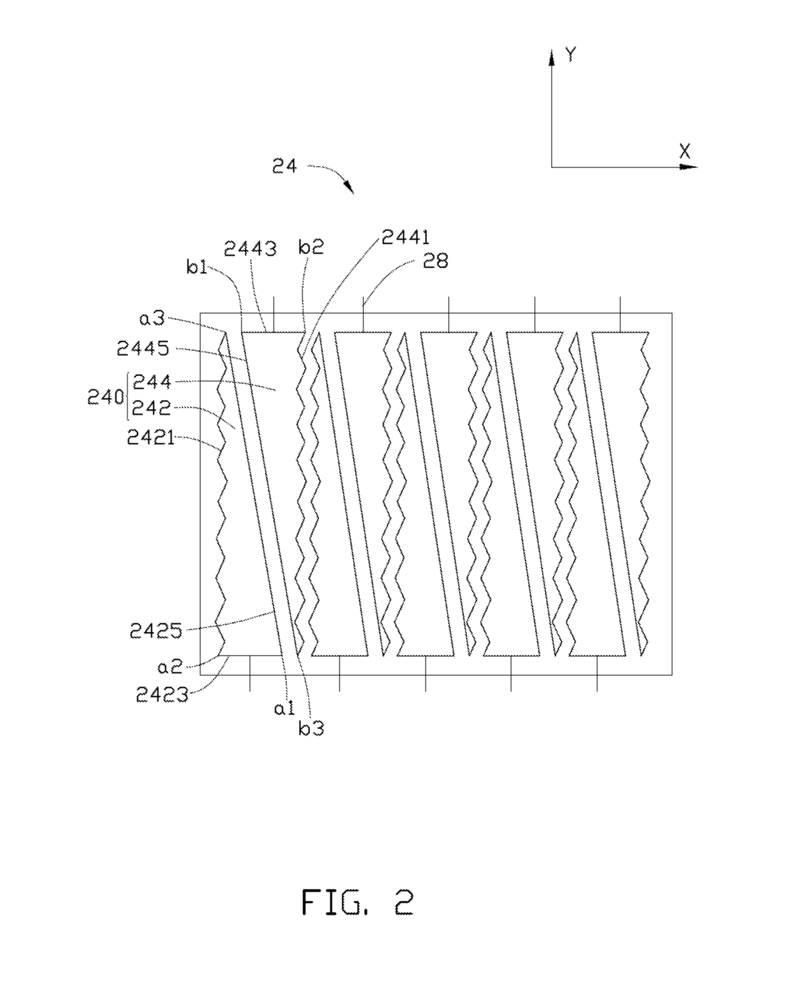

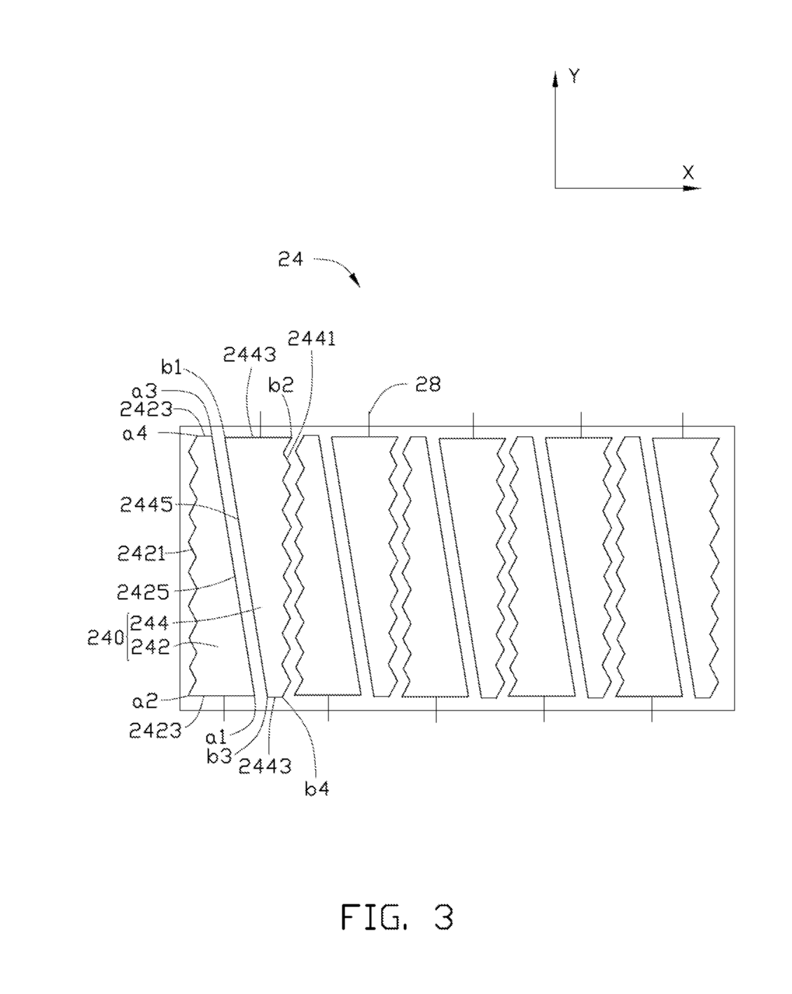

Referring to FIGS. 2 and 3, the transparent conductive layer 24 is a patterned transparent conductive layer. The pattern is configured as a plurality of right triangles, as shown in FIG. 2. The pattern is also configured as a plurality of right angled trapezoids, as shown in FIG. 3. There are an X direction and a Y direction perpendicular to the X direction in one plane parallel to a surface of the transparent conductive layer 24.

The transparent conductive layer 24 is etched or patterned to a plurality of pairs of sensor electrodes 240 spaced with each other and arranged adjacent to each other in the X direction. That is, the transparent conductive layer 24 includes a plurality of pairs of sensor electrodes 240 arranged adjacent to each other in the X direction. A distance between two adjacent pairs of sensor electrodes 240 is equal. The distance between two adjacent pairs of sensor electrodes 240 can be in a range from about 0.02 millimeters to about 0.3 millimeters. In one embodiment, the distance between two adjacent pairs of sensor electrodes 240 is about 0.03 millimeters.

Each of the plurality of pairs of sensor electrodes 240 includes a first electrode 242 and a second electrode 244 spaced to each other. In each of the plurality of pairs of sensor electrodes 240, a distance between the first electrode 242 and the second electrode 244 can be in a range from about 0.02 millimeters to about 0.3 millimeters. In one embodiment, the distance between the first electrode 242 and the second electrode 244 is 0.03 millimeters.

As shown in FIG. 2, a pattern of the first electrode 242 is generally a right triangle with a saw like side. The pattern of the first electrode 242 has a first side 2421, a second side 2423 parallel to the X direction and a third side 2425. The second side 2423 has a first end a1 and a second end a2 opposite to the first end a1. The third side 2425 has the first end a1 and a third end a3 opposite to the first end a1. The second side 2423 is connected to the third side 2425 by the first end a1. If the second end a2 is connected with the third end a3 by a straight line, the straight line is perpendicular to the second side 2423. The first side 2421 connecting the second end a2 with the third end a3 is curved or formed in zigzag patterns.

As shown in FIG. 2, a pattern of the second electrode 244 is also generally a right triangle with a saw like side. The pattern of the second electrode 244 has a fourth side 2441, a fifth side 2443 parallel to the X direction and a sixth side 2445. The fifth side 2443 has a fourth end b1 and a fifth end b2 opposite to the fourth end b1. The sixth side 2445 has the fourth end b1 and a sixth end b3 opposite to the fourth end b1. The fifth side 2443 is connected to the sixth side 2445 by the fourth end b1. If the fifth end b2 is connected with the sixth end b3 by a straight line, the straight line is perpendicular to the fifth side 2443. The fourth side 2441 connecting the fifth end b2 with the sixth end b3 is curved or formed in zigzag patterns.

As shown in FIG. 3, a pattern of the first electrode 242 is generally a right angled trapezoid with a saw like side. The pattern of the first electrode 242 has the first side 2421, the second side 2423 parallel to the X direction, the third side 2425, and a seventh side 2427 opposite to the second side 2423 and parallel to the X direction. The second side 2423 is connected to the third side 2425 by the first end a1. The seventh side 2427 is connected to the third side 2425 by the third end a3. The seventh side 2427 has a seventh end a4 opposite to the third end a3. If the second end a2 is connected with the seventh end a4 by a straight line, the straight line is perpendicular to the second side 2423. The first side 2421 connecting the second end a2 with the seventh end a4 is curved or formed in zigzag patterns.

As shown in FIG. 3, a pattern of the second electrode 244 is generally a right angled trapezoid with a saw like side. The pattern of the second electrode 244 has the fourth side 2441, the fifth side 2443 parallel to the X direction, the sixth side 2445, and a eighth side 2447 opposite to the fifth side 2443 and parallel to the X direction. The fifth side 2443 is connected to the sixth side 2445 by the fourth end b1. The eighth side 2447 is connected to the sixth side 2445 by the sixth end b3. The eighth side 2447 has a eighth end b4 opposite to the sixth end b3. If the fifth end b2 is connected with the eighth end b4 by a straight line, the straight line is perpendicular to the fifth side 2443. The fourth side 2441 connecting the fifth end b2 with the eighth end b4 is curved or formed in zigzag patterns.

In each of the plurality of pairs of sensor electrodes 240, the third side 2425 of the first electrode 242 is adjacent to and parallel to the sixth side 2445 of the second electrode 244.

In each of the plurality of pairs of sensor electrodes 240, when patterns of the first electrode 242 and the second electrode 244 are designed as right triangles, the two right triangles have the same shape and size. In each of the plurality of pairs of sensor electrodes 240, when patterns of the first electrode 242 and the second electrode 244 are designed as right angled trapezoids, the two right angled trapezoids have the same shape and size. A width of the first electrode gradually increases, and a width of the second electrode gradually reduces in the Y direction.

The at least two wires 28 are used to connect the first electrode 242 with an external circuit. The at least two wires 28 are also used to connect the second electrode 244 with the external circuit. The at least two wires 28 have good conductive properties and flexibility. The at least two wires 28 can be made of metal or carbon nanotube wire. In one embodiment, the at least two wires 28 are made of silver. The number of the at least two wires 28 is equal to the total number of the first electrode 242 and the second electrode 244. That is, each of the at least two wires 28 is connected to one first electrode 242 or one second electrode 244.

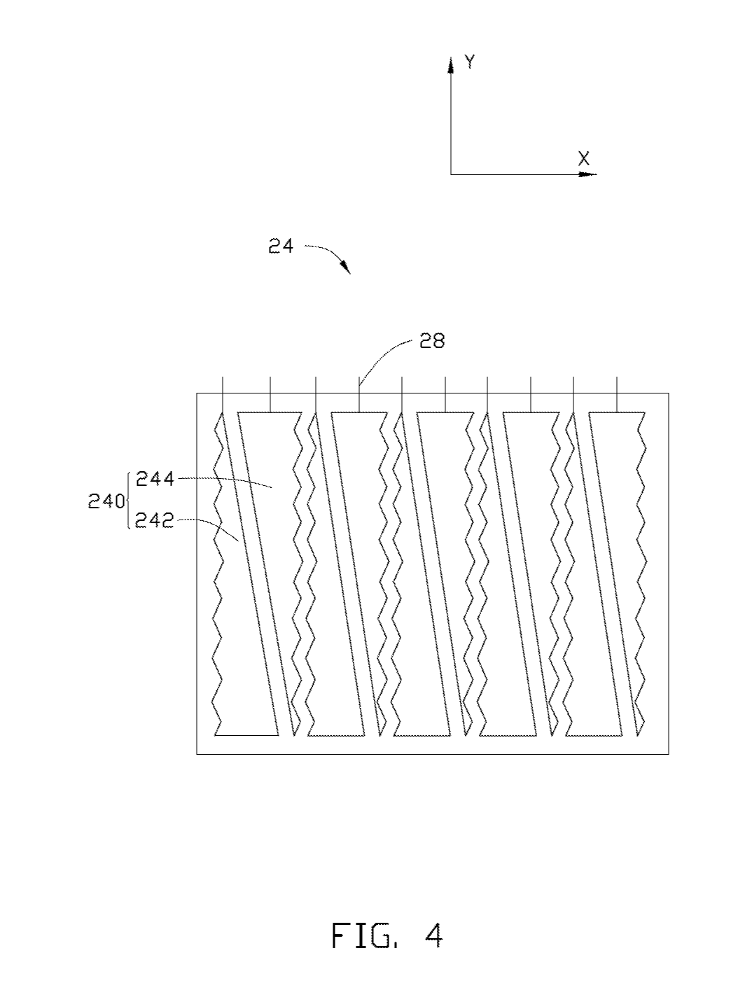

The at least two wires 28 can be located on two opposite sides of the transparent conductive layer 24, and electrically connected to the first electrode 242 and the second electrode 244, as shown in FIGS. 2 and 3. The at least two wires 28 can be only located on one side of the transparent conductive layer 24, and electrically connected to the first electrode 242 and the second electrode 244, as shown in FIG. 4. When the at least two wires 28 can be only located on one side of the transparent conductive layer 24, a wiring space of the at least two wires 28 can be saved.

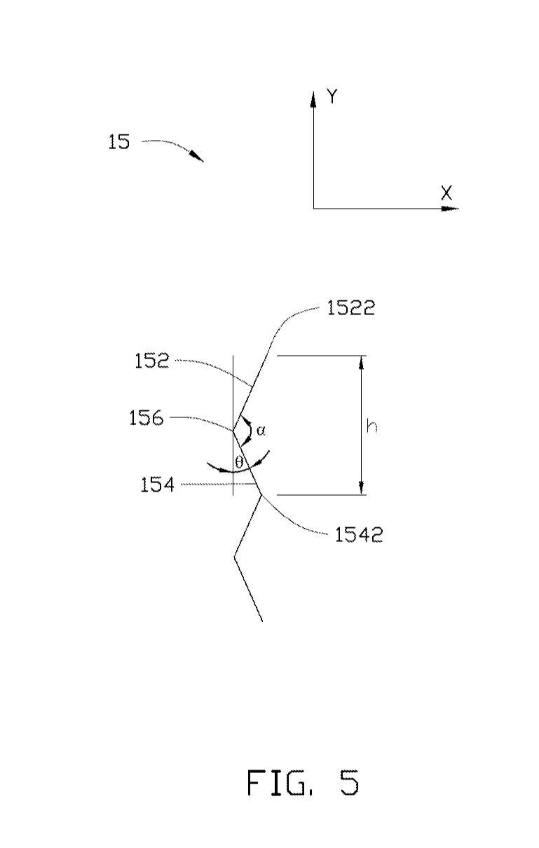

Referring to FIG. 5, in the right triangle or the right angled trapezoid, the zigzag patterns includes a plurality of zigzag shapes 15 having the same size. In detail, each of the plurality of zigzag shapes 15 includes a ninth side 152 and a tenth side 154. The ninth side 152 and the tenth side 154 form an angle designed as α, wherein the α can be in a range from about 164 degrees to about 172 degrees. Therefore, when the touch panel 20 is assembled with a liquid crystal display module, there is minimal or no Moire' effects. A visual identification and operation to the touch panel 20 can be improved.

The ninth side 152 has a ninth end 1522 away from the angle α, and the tenth side 154 has a tenth end 1542 away from the angle α. A direction from the ninth end 1522 of the ninth side 152 to the tenth end 1542 of the tenth side 154 is parallel to the Y direction. A distance between the ninth end 1522 of the ninth side 152 and the tenth end 1542 of the tenth side 154 is designed as h, wherein the h can be in a range from about 2 millimeters to about 2.5 millimeters. The angle α has a vertex point 156. A distance between the vertex point 156 and a line connecting the ninth end 1522 with the tenth end 1542 is related to the ninth side 152, the tenth side 154 and the angle α. In one embodiment, the distance between the vertex point 156 and a line connecting the ninth end 1522 with the tenth end 1542 is less than or equal to about 160 microns.

In one embodiment, in each of the plurality of zigzag shape 15, the ninth side 152 and the tenth side 154 has the same length. An angle between the ninth side 154 and the Y direction is designed as θ, an angle between the tenth side 154 and the Y direction is also designed as θ, wherein the θ can be in a range from about 4 degrees to about 8 degrees.

The transparent conductive layer 24 can be made of transparent conductive materials, for example, indium tin oxide (ITO), antimony tin oxide (ATO), silver thin film, nickel-gold thin film, Polyethylene dioxythiophene two (PEDOT), or carbon nanotube layer. In one embodiment, the transparent conductive layer 24 is made of ITO. A thickness of the transparent conductive layer 24 can be in a range from about 1 micron to about 500 microns. In one embodiment, the thickness of the transparent conductive layer 24 is 125 microns.

It is to be understood, a shape of the transparent conductive layer 24 and the substrate 22 can be selected according to a shape of touch area of the touch panel 20. The shape of touch area of the touch panel 20 can be a wire, triangle or rectangle. In one embodiment, the shape of touch area of the touch panel 20 is a rectangle.

Further, in order to prolong operational life span and restrict coupling capacitance of the touch panel 20, the protective layer 26 is located on the plurality of pairs of sensor electrodes 240 and the transparent conductive layer 24. The material of the protective layer 26 can, e.g., be selected from a group consisting of silicon nitride, silicon dioxide, benzocyclobutenes (BCB), polyester film, and polyethylene terephthalate. The protective layer 26 can be a slick plastic film and receive a surface hardening treatment to protect the plurality of pairs of sensor electrodes 240 and the transparent conductive layer 24 from being scratched when in use.

In one embodiment, the protective layer 26 is silicon dioxide. A hardness and thickness of the protective layer 26 are selected according to practical needs. In one embodiment, the hardness of the protective layer 26 is 7 HB. The protective layer 26 is adhered to the transparent conductive layer 24, e.g., via an adhesive.

The touch panel 20 can further include a shielding layer 25 located on the second surface 222 of the substrate 22. A material of the shielding layer 25 can be indium tin oxide, antimony tin oxide, carbon nanotube film, and/or another conductive material. In one embodiment, the shielding layer 25 is a carbon nanotube film. The carbon nanotube film includes a plurality of carbon nanotubes, and an orientation of the carbon nanotubes therein may be arbitrarily determined. In one embodiment, the carbon nanotubes in the carbon nanotube film are arranged along a same direction. The carbon nanotube film is connected to ground and acts as a shield, thus enabling the touch panel 20 to operate without interference (such as electromagnetic interference).

It is to be understood, the touch panel 20 includes some necessary elements (not illustrated). Materials and structures of the necessary elements can be selected according to conventional touch panel.

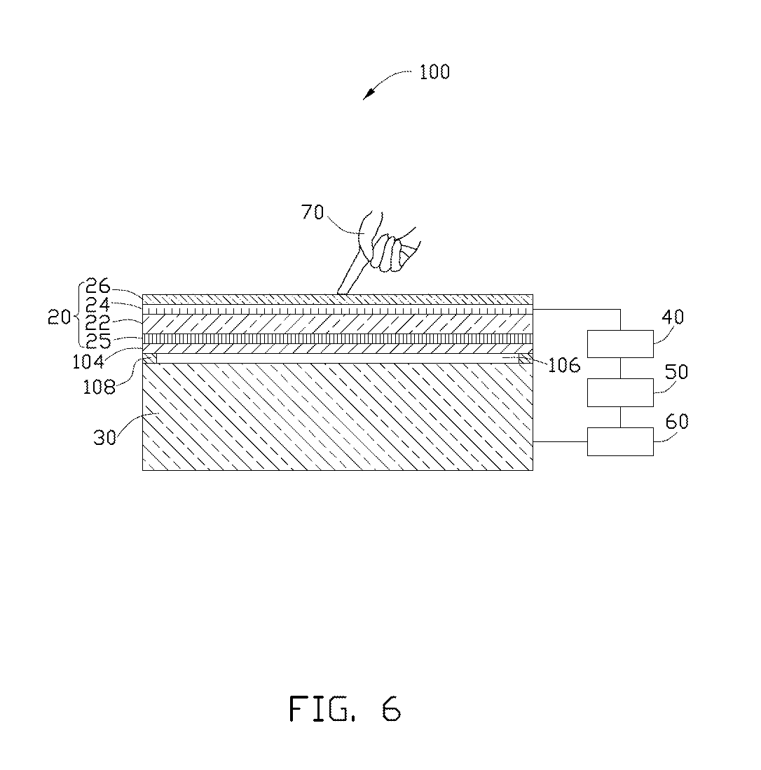

Referring to FIG. 6, a liquid crystal display device 100 of one embodiment includes the touch panel 20, a liquid crystal display element 30, a touch panel controller 40, a central processing unit (CPU) 50, and a liquid crystal display element controller 60. The touch panel 20 is connected to the touch panel controller 40 by the at least two wires 28. The touch panel 20 can be spaced at a distance from the liquid crystal display element 30 or, alternatively, can be installed directly on the liquid crystal display element 30. The touch panel controller 40, the CPU 50, and the liquid crystal display element controller 60 are electrically connected. The CPU 50 is connected to the liquid crystal display element controller 60 to control the liquid crystal display element 30.

When the shielding layer 25 is located on the second surface 222 of the substrate 22, a passivation layer 104 is located on and in contact with a surface of the shielding layer 25 that faces away from the substrate 22. The material of the passivation layer 104 can be silicon nitride or silicon dioxide. The passivation layer 104 can be spaced from the liquid crystal display element 30 with a certain distance or, can be directly installed on the liquid crystal display element 30. When the passivation layer 104 is spaced from the liquid crystal display element 30 with a distance, two or more spacers 108 can be used. Thereby, a gap 106 is provided between the passivation layer 104 and the liquid crystal display element 30. The passivation layer 104 can protect the shielding layer 25 from chemical or mechanical damage.

In operation, the touch panel controller 40 is used to detect coordinates of a touch point by a finger 70 on the touch panel 20. Then, the touch panel controller 40 sends the coordinates of the touch point to the CPU 50. The CPU 50 receives and processes the coordinates into a command. Finally, the CPU 50 sends out the command to the liquid crystal display element controller 60. The liquid crystal display element controller 60 controls the display of the liquid crystal display element 30 accordingly.

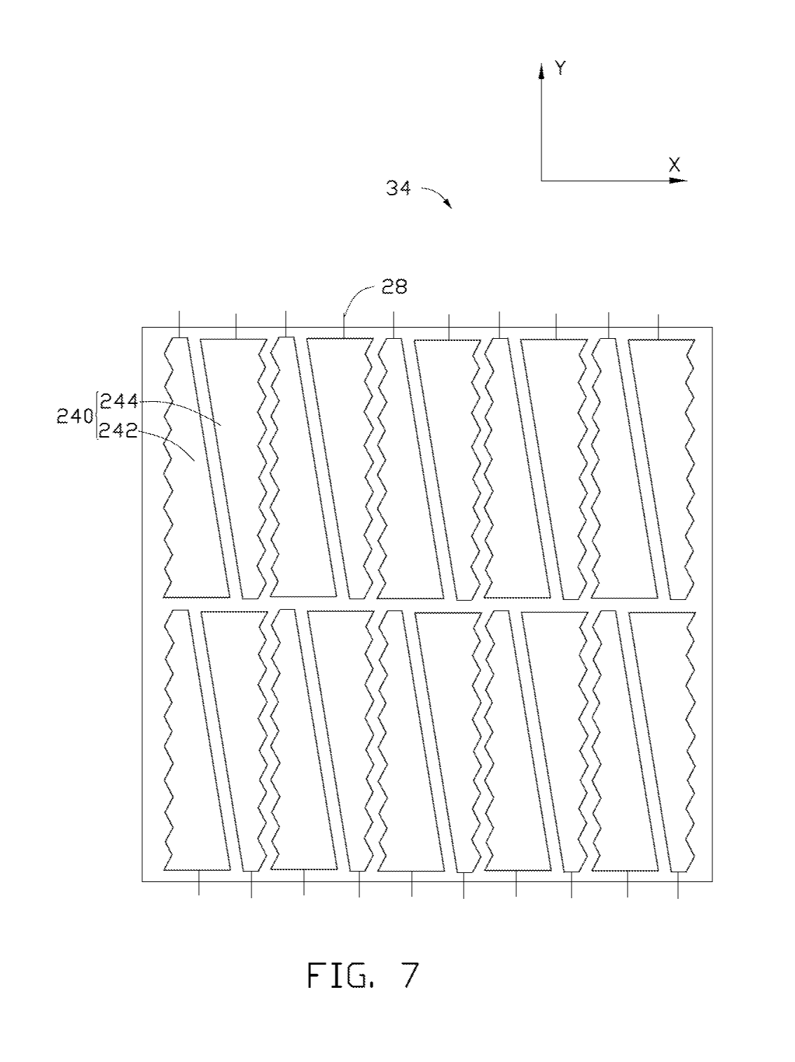

Referring to FIG. 7, another embodiment of the transparent conductive layer 34 is shown where the plurality of pairs of sensor electrodes 240 is arranged adjacent to each other in the X direction and the Y direction. In one embodiment, two pairs of sensor electrodes 240 are arranged adjacent to each other in the X direction, and five pairs of sensor electrodes 240 are arranged adjacent to each other in the Y direction. In one embodiment, the at least two wires 28 is located on two opposite sides of the transparent conductive layer 34. Each of the plurality of pairs of sensor electrodes 240 is an independent sensor electrode unit.

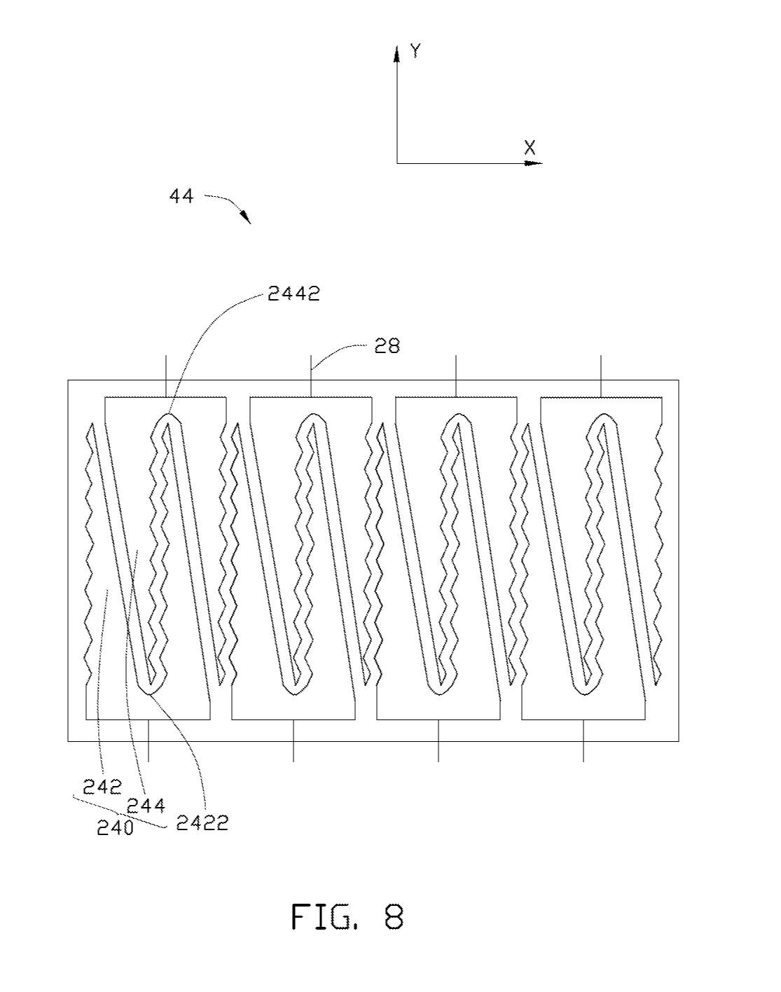

Referring to FIG. 8, yet another embodiment of the transparent conductive layer 44 is shown where each of the plurality of pairs of sensor electrodes 240 includes a plurality of first electrodes 242 and a plurality of second electrodes 244 opposite to the plurality of first electrodes 242. The plurality of first electrodes 242 and the plurality of second electrodes 244 are alternatively stacked and spaced to each other in X direction. In each of the plurality of pairs of sensor electrodes 240, the plurality of first electrodes 242 is electrically connected to each other, and the plurality of second electrodes 244 is electrically connected to each other.

In one embodiment, the plurality of first electrodes 242 is connected to each other by a first connection section 2422 to form an electrode in a comb shape, and the plurality of second electrodes 244 is connected to each other by a second connection section 2442 to form an electrode in the comb shape. It is to be understood, the first connection section 2422 and the second connection section 2442 are formed by etching the transparent conductive layer 44. The at least two wires 28 is located on two opposite sides of the transparent conductive layer 44. Each of the plurality of pairs of sensor electrodes 240 is an independent sensor electrode unit.

In summary, in the transparent conductive layer 24, 34, 44, a leg of the right triangle or the right angled trapezoid extending in a zigzag pattern. The pixels of the liquid crystal display element 30 are arranged in a ribbon shape. Therefore, there is no causing interference of light, and no Moire' effects. A visual identification and operation to the touch panel 20 can be improved.

It is to be understood that the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

It is also to be understood that the above description and the claims drawn to a method may include some indication in reference to certain steps. However, the indication used is only to be viewed for identification purposes and not as a suggestion as to an order for the steps.

What is claimed is:

1. A touch panel, comprising:
a substrate with a surface, wherein an X direction and a Y direction are defined on the surface, and the X direction is perpendicular to the Y direction; and
a patterned transparent conductive layer located on the surface of the substrate, the patterned transparent conductive layer comprises a plurality of pairs of sensor electrodes arranged adjacent to each other in the X direction, each of the plurality of pairs of sensor electrodes comprises a first electrode and a second electrode opposite to the first electrode, a pattern of the first electrode and the second electrode is right triangle shape or right angled trapezoid shape, and one side of the right triangle shape or the right angled trapezoid shape parallel to the Y direction extends in a plurality of zigzag shapes.

2. The touch panel of claim 1, wherein a width of the first electrode gradually increases, and a width of the second electrode gradually reduces in the Y direction.

3. The touch panel of claim 1, wherein each of the plurality of zigzag shapes comprises a first side and a second side forming an angle designed as α, wherein the α is in a range from about 164 degrees to about 172 degrees.

4. The touch panel of claim 3, wherein an angle between the first side and the Y direction is equal to an angle between the second side and the Y direction, and a length of the first side is equal to a length of the second side.

5. The touch panel of claim 3, wherein the first side has a first end away from the angle α, and the second side has a second end away from the angle α, and a distance between the first end and the second end is designed as h, wherein the h is in a range from about 2 millimeters to about 2.5 millimeters.

6. The touch panel of claim 5, wherein the angle α has a vertex point, a distance between the vertex point and a line connecting the first end with the second end is less than or equal to about 160 microns.

7. The touch panel of claim 1, wherein a distance between two adjacent pairs of sensor electrodes is in a range from about 0.02 millimeters to about 0.3 millimeters.

8. The touch panel of claim 1, wherein a distance between the first electrode and the second electrode is in a range from about 0.02 millimeters to about 0.3 millimeters.

9. The touch panel of claim 1, further comprising a plurality of wires electrically connected with the first electrode and the second electrode.

10. The touch panel of claim 1, wherein the plurality of pairs of sensor electrodes comprises a plurality of the first electrodes and a plurality of the second electrodes alternatively stacked and spaced to each other in the X direction.

11. The touch panel of claim 1, wherein the plurality of pairs of sensor electrodes arranged adjacent to each other in the Y direction.

12. The touch panel of claim 11, wherein two pairs of sensor electrodes are arranged adjacent to each other in the X direction, and five pairs of sensor electrodes are arranged adjacent to each other in the Y direction.

13. A touch panel, comprising:
a substrate with a surface, wherein an X direction and a Y direction are defined on the surface, and the X direction is perpendicular to the Y direction; and
a patterned transparent conductive layer located on the surface of the substrate, the patterned transparent conductive layer comprises a plurality of pairs of sensor electrodes arranged adjacent to each other in the X direction, each of the plurality of pairs of sensor electrodes comprises a plurality of first electrode and a plurality of second electrode alternatively stacked, a pattern of the plurality of first electrode and the plurality of second electrode is right triangle shape or right angled trapezoid shape, and one side of the right triangle shape or the right angled trapezoid shape parallel to the Y direction extends in a plurality of zigzag shapes.

14. The touch panel of claim 13, wherein the plurality of first electrodes is connected to each other by a first connection section to form an electrode in a comb shape.

15. The touch panel of claim 13, wherein the plurality of second electrodes is connected to each other by a second connection section to form an electrode in the comb shape.

16. The touch panel of claim 13, wherein a width of the plurality of first electrode gradually increases, and a width of the plurality of second electrode gradually reduces in the Y direction.

17. The touch panel of claim 13, wherein each of the plurality of zigzag shapes comprises a first side and a second side forming an angle designed as α, wherein the α is in a range from about 164 degrees to about 172 degrees.

18. The touch panel of claim 17, wherein an angle between the first side and the Y direction is equal to an angle between the second side and the Y direction, and a length of the first side is equal to a length of the second side.

19. The touch panel of claim 17, wherein the first side has a first end away from the angle α, and the second side has a second end away from the angle α, and a distance between the first end and the second end is designed as h, wherein the h is in a range from about 2 millimeters to about 2.5 millimeters.

20. A liquid crystal display device, comprising:
A touch panel comprising:
a substrate with a surface, wherein an X direction and a Y direction are defined on the surface, and the X direction is perpendicular to the Y direction; and
a patterned transparent conductive layer located on the surface of the substrate, the patterned transparent conductive layer comprises a plurality of pairs of sensor electrodes arranged adjacent to each other in the X direction, each of the plurality of pairs of sensor electrodes comprises a first electrode and a second electrode opposite to the first electrode, a pattern of the first electrode and the second electrode is right triangle shape or right angled trapezoid shape, and one side of the right triangle shape or the right angled trapezoid shape parallel to the Y direction extends in a plurality of zigzag shapes; and
a liquid crystal display element directly installed on a surface of the substrate away from the patterned transparent conductive layer.
